(19) United States
(12) Patent Application Publication
(10) Pub. No.: US 2026/0350628 A1
(43) Pub. Date: Nov. 5, 2026

(54) ADAPTIVE SUPPORT AND MANAGEMENT

(71) Applicant: NCR Voyix Corporation, Atlanta, GA (US)

(72) Inventors: Jacob Regis Cronauer, Marietta, GA (US); Michael Jiang Tang, Alpharetta, GA (US); Kun Zhu, Smyrna, GA (US); Yung-Hang Chang, Marietta, GA (US)

(21) Appl. No.: 19/194,680

(22) Filed: Apr. 30, 2025

(51) Int. Cl. G06Q 30/015; H04L 41/5074; H04L 51/216

(52) U.S. Cl. CPC G06Q 30/015; H04L 41/5074; H04L 51/216

(57) ABSTRACT

A multipurpose agent interface enables store employees to access multimedia break-fix solutions through a knowledge base. The methods and system distribute solutions, recognizes trending issues, alerts management, and engages live help desk operators when needed. Asynchronous conversations allow different workers to continue issue resolution across shift changes. The methods and system adapt to each store's unique operating conditions, providing customized support based on location-specific factors.

### BACKGROUND

Restaurant workers face continuous operational challenges while managing their stores, requiring them to tackle various issues simultaneously. The existing customer service infrastructure treats all locations uniformly, despite stores operating in diverse geographical areas with unique environmental conditions that affect their operations differently. Additionally, the quick service environment, where employees rotate through shorter shifts, presents particular challenges with respect to the efficient transfer of ongoing issues to incoming staff members.

### BRIEF DESCRIPTION OF THE DRAWINGS

FIG. 1 is a diagram of a system for adaptive support and management, according to an example embodiment.

FIG. 2 is a flow diagram of a method for adaptive support and management, according to an example embodiment.

FIG. 3 is a flow diagram of another method for adaptive support and management, according to an example embodiment.

### DETAILED DESCRIPTION

Quick service restaurant operations present challenges for staff members in addressing technical and operational issues while simultaneously maintaining efficient store operations. The complexity increases as employees rotate through shorter shifts, creating potential gaps in issue tracking and resolution continuity. Current support systems lack the ability to effectively transfer ongoing issue status between shifting staff members.

Environmental and geographical variations between store locations create distinct operational challenges as well. For instance, stores in more humid environments may experience different equipment maintenance needs compared to stores in less extreme weather environments, or stores in rural settings may present different equipment issues than stores in urban settings, and so forth. Traditional support systems, however, do not account for these location-specific variations.

A number of technical challenges present themselves in this context, including the technical challenge of developing a unified digital interface that can effectively process, analyze, and respond to store-specific issues while maintaining conversation continuity across shift changes, the technical challenge of integrating with multiple backend systems, and the technical challenge of adapting support responses based on location-specific operational conditions. Additionally, the technical complexity extends to creating a system that can synthesize knowledge from various sources, determine appropriate response formats between text, images and video, and seamlessly transition between automated assistance and live help desk operators when necessary.

The technology disclosed herein relates to, among other things, improved computer-implemented customer support systems that provide a technical solution to the above-mentioned technical problems in the form of a specialized application architecture that integrates knowledge synthesis, incident management, and live support capabilities. The system employs advanced natural language processing to understand user intent, retrieve relevant solutions from a proprietary knowledge base, and seamlessly transition between automated and human support as necessary.

In various embodiments of the technology disclosed herein, the application executes on in-store devices, providing an interface through which employees interact with a multipurpose agent. This agent leverages a proprietary knowledge base to distribute multimedia break-fix solutions, incorporating text, images, and video content as needed.

In an embodiment, the methods and system implement asynchronous conversation capabilities, enabling different workers to review and continue ongoing conversations during shift changes. This functionality provides incoming staff immediate access to issue context and status.

In an embodiment, the methods and system adapt to store-specific conditions by learning from historical interactions and environmental factors. This location-aware functionality enables customized support responses that account for unique operational conditions at each store.

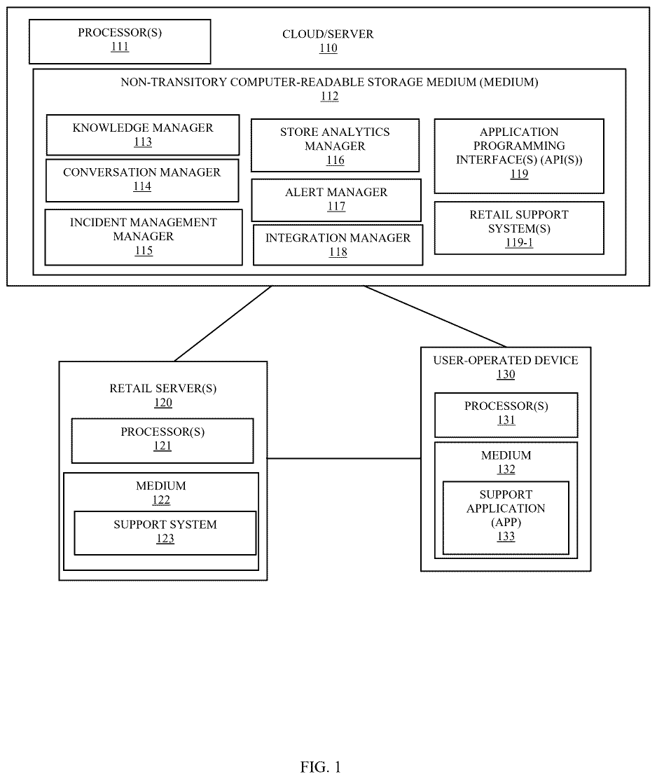

FIG. 1 is a diagram of a system 100 for adaptive support and management, according to an example embodiment. It is to be noted that the components are shown schematically in greatly simplified form, with only those components relevant to understanding of the embodiments being illustrated.

Furthermore, the various components (that are identified in FIG. 1) are illustrated and the arrangement of the components is presented for purposes of illustration only. It is to be noted that other arrangements with more or less components are possible without departing from the teachings of adaptive support and management presented herein and below.

System 100 includes a cloud 110 or a server 110 (hereinafter just “cloud 110” or “cloud server 110”), one or more retail servers 120, and one or more user-operated devices 130. Cloud 110 includes a processor 111 and a non-transitory computer-readable storage medium (medium) 112, which includes executable instructions for a knowledge manager 113, a conversation manager 114, an incident management manager 115, a store analytics manager 116, an alert manager 117, an integration manager 118, one or more application programming interfaces (APIs) 119, and an optional retail support system 119-1. Processor 111 executes the instructions causing processor 111 to perform operations discussed herein and below with respect to 113-119-1.

Each retailer server 120 includes a processor 121 and a non-transitory computer-readable storage medium 122, which includes instructions for a support system 123. Processor 121 executes the instructions causing processor 121 to perform operations discussed herein and below with respect to support system 123.

Each user-operated device 130 includes a processor 131 and a non-transitory computer-readable storage medium 132, which includes executable instructions for a support application 133. Processor 131 executes the instructions causing processor 131 to perform operations discussed herein and below with respect to support application 133.

The knowledge manager 113 analyzes user inputs to identify relevant support content from a proprietary knowledge base, enabling distribution of multimedia break-fix solutions including text, images, and video content as needed. The knowledge manager 113 integrates with the conversation manager 114 to maintain context across user interactions. The user inputs include natural language conversations with the users along with any user-attached images, documents, and/or video for the conversations. The natural language conversations may be via written natural language text or via natural language speech provided by the users.

The conversation manager 114 implements asynchronous conversation capabilities that enable different workers to review and continue ongoing conversations during shift changes. The conversation manager 114 maintains conversation threads and provides incoming staff immediate access to issue context and status across multiple user shifts.

The incident management manager 115 functions as a conductor agent that interfaces with a retailer's help desk through support system 123 while managing the lifecycle of help desk tickets. The incident management manager 115 maintains ticket state within a single session, enabling different users changing shifts to seamlessly continue work on previously opened tickets. When the incident management manager 115 identifies a different ticket having a similar issue to a given ticket, it employs a sophisticated correlation engine that analyzes multiple ticket attributes including equipment type, error codes, environmental conditions, and resolution steps to determine issue similarity. The correlation engine generates a similarity score based on these attributes and automatically updates tickets that exceed a configurable similarity threshold. For matching tickets, the system automatically enriches the given ticket's session with relevant resolution details, including successful troubleshooting steps, environmental impact analysis, and maintenance procedures from the different ticket. The system implements an intelligent highlighting system that visually emphasizes the related ticket information within the current session's context while maintaining clear delineation between original and imported content. Additionally, the system provides bidirectional hyperlinks between related ticket sessions, enabling users to efficiently navigate between connected issues while preserving the distinct context of each conversation thread. This correlation and linking mechanism integrates with the knowledge manager 113 to incorporate relevant knowledge base articles and with the store analytics manager 116 to factor in location-specific environmental conditions that may impact issue resolution.

The store analytics manager 116 analyzes patterns in equipment issues based on store location data and environmental conditions. This enables the system 100 to adapt support responses based on store-specific operational conditions, such as customizing maintenance procedures for stores in humid environments.

The alert manager 117 identifies trending issues across multiple conversations and generates notifications to store management regarding recurring problems. The alert manager 117 works in conjunction with the store analytics manager 116 to correlate equipment issues with environmental data.

The integration manager 118 coordinates communication between components through APIs 119, enabling seamless interaction between the knowledge base, incident management, and live support capabilities. The integration manager 118 can interface with either an optional retail support system 119-1 hosted in cloud 110 or a support system 123 hosted on retail server 120.

Support application 133 executing on user-operated device 130 provides an interface through which employees interact with the various managers and systems. The support application 133 maintains session state across different users and shift changes while interfacing with both cloud 110 and retail server 120.

In an embodiment, the support application 133 provides a home interface that displays available applications including a store health chat option and a knowledge base option. The store health chat enables users to initiate new conversations or continue existing chat sessions. The knowledge base provides direct access to support documentation and solutions.

In an embodiment, the support application 133 implements a chat session interface that displays open cases with critical information including case numbers, status, priority levels, service level agreement (SLA) metrics, technician assignments, and timestamps. The interface enables users to view case details, access chat history, and continue conversations seamlessly across shift changes. The chat interface also provides capabilities for attaching and viewing multimedia content including images and video related to the issues being discussed.

In an embodiment, the support application 133 maintains conversation threads that preserve the full context of issue discussions, including automated responses, knowledge base content, and live agent interactions. The interface highlights related tickets when similar issues are identified and provides direct links to access the session details of those related tickets, enabling users to leverage resolution information across multiple support cases.

In an embodiment, the system 100 integrates with an incident management service through a corresponding API, enabling create, read, update, delete (CRUD) operations on tickets via the incident management manager 115. The integration provides updates on ticket status and SLA progress through APIs 119.

In an embodiment, the knowledge manager 113 implements a knowledge base RAG (Retrieval-Augmented Generation) service that allows searches for customer-specific knowledge articles and provides summarized troubleshooting steps. A knowledge base index service periodically updates the knowledge base into a semantic searchable index to maintain current support content.

In an embodiment, the knowledge base RAG service implements vector embeddings to create semantic representations of support articles and user queries, enabling more accurate matching between issues and solutions. The knowledge manager 113 uses these embeddings along with natural language processing to dynamically rank and retrieve relevant support content based on contextual similarity rather than simple keyword matching.

In an embodiment, the incident management manager 115 integrates with APIs to enable smooth transition from automated support to live system agents when needed. A schedule callback API enables requesting callbacks with options for specific timing and phone numbers.

In an embodiment, the incident management manager 115 implements an intelligent routing algorithm that analyzes ticket content, historical resolution patterns, and agent expertise to optimize assignment of issues to appropriate support resources. The system 100 tracks resolution effectiveness metrics and automatically adjusts routing decisions based on observed outcomes to improve support efficiency.

In an embodiment, the conversation manager 114 leverages artificial intelligence (AI) chatbot workflows for intent understanding and routing, parsing employee input to understand inquiry intent and route requests accurately to engage relevant IT services or agents. The system 100 enables sophisticated natural language processing capabilities that allow for contextual understanding of user requests and automated routing to the most appropriate support resources.

In an embodiment, the knowledge manager 113 works in conjunction with the conversation manager 114 to analyze natural language inputs and determine user intent, while the incident management manager 115 creates and tracks support tickets based on the conversation context. The integrated analysis enables the store analytics manager 116 to identify patterns in equipment issues, which the alert manager 117 then processes to generate targeted notifications about trending issues across the retail environment.

In an embodiment, the knowledge manager 113 works in conjunction with the conversation manager 114 to analyze natural language inputs through a multi-stage pipeline that includes intent classification, entity extraction, and contextual understanding, while the incident management manager 115 creates and tracks support tickets based on the processed conversation context. The integrated analysis enables the store analytics manager 116 to identify patterns in equipment issues using machine learning algorithms that correlate failure modes with environmental factors, which the alert manager 117 then processes to generate targeted notifications about trending issues across the retail environment.

In an embodiment, the knowledge manager 113 implements a multi-stage natural language processing pipeline that begins with input preprocessing and normalization. The system 100 processes both text-based conversations and transcribed speech input, applying tokenization and linguistic normalization while preserving any attached multimedia content such as images or video that provide additional context for the issue being reported.

In an embodiment, the knowledge manager 113 performs intent classification through a hierarchical analysis model that first identifies broad categories of issues (such as equipment failures, maintenance requests, or operational questions) before determining specific intents within each category. The system 100 leverages AI chatbot workflows capabilities to map user inputs to predefined intents while maintaining flexibility to handle novel issue descriptions.

In an embodiment, the knowledge manager 113 executes entity extraction through a specialized model trained on retail equipment and operational terminology. The system 100 identifies and extracts key entities including equipment types, environmental conditions, error codes, and operational parameters, while maintaining relationships between extracted entities to preserve the full context of the reported issue.

In an embodiment, the knowledge manager 113 integrates with the knowledge base RAG service to perform semantic matching between processed user inputs and stored support content. The system 100 generates vector embeddings of the processed input, including extracted entities and classified intents, enabling contextual retrieval of relevant support documentation, maintenance procedures, and resolution steps.

In an embodiment, the knowledge manager 113 maintains a feedback loop that tracks the effectiveness of intent classification and entity extraction across conversations. The system 100 analyzes resolution outcomes to automatically refine its classification models and entity recognition patterns, improving accuracy for future interactions while adapting to new equipment types and environmental conditions.

In an embodiment, the knowledge manager 113 implements a cache coherency protocol that ensures consistent access to knowledge base content across multiple active sessions. When the knowledge base is updated, the system 100 propagates changes through a publish-subscribe mechanism that notifies active sessions of content updates while maintaining version control of knowledge base articles being accessed.

In an embodiment, the knowledge manager 113 implements a version control system for knowledge base content that maintains a complete history of article revisions and updates. The system 100 tracks which version of each knowledge base article was used in previous support sessions, enabling retroactive analysis of resolution effectiveness and ensuring consistent support information across related tickets even as the knowledge base evolves.

In an embodiment, the conversation manager 114 implements a stateful conversation tracking system that maintains separate conversation contexts for active issues while preserving historical thread continuity. The system 100 employs a session management framework that tags conversations with unique identifiers linking related ticket information, knowledge base content, and user interactions, enabling seamless thread reconstruction when conversations are resumed across shifts.

In an embodiment, the conversation manager 114 coordinates with the incident management manager 115 to implement a structured handoff protocol during shift transitions. When a new user accesses an existing conversation thread, the system 100 automatically loads the full conversation context including ticket status, previous interactions, and any linked knowledge base content or resolution attempts, while maintaining the sequential integrity of all interactions.

In an embodiment, the conversation manager 114 maintains conversation state through a multi-layered data structure that separates active conversation elements from historical context. The active layer tracks current issue status, pending responses, and immediate context, while the historical layer maintains the full conversation thread including automated responses, knowledge base content, and live agent interactions, enabling comprehensive context preservation during shift transitions.

In an embodiment, the conversation manager 114 implements an intelligent thread linking system that automatically associates related conversations based on issue similarity, equipment type, and environmental factors. The system 100 maintains bidirectional references between linked threads, enabling users to navigate between related issues while preserving the distinct context of each conversation. This linking mechanism integrates with the incident management manager 115 to synchronize ticket states and resolution information across related threads.

In an embodiment, the incident management manager 115 implements a ticket lifecycle management system that tracks tickets from creation through resolution using a state machine architecture. The system 100 maintains ticket states including creation, assignment, in-progress, pending, and resolved, while preserving the complete history of state transitions and associated conversation context for each ticket.

In an embodiment, the incident management manager 115 coordinates with the incident management service through the incident management API to enable bidirectional ticket status synchronization. When ticket updates occur in either system 100, the incident management manager 115 ensures consistent state representation while maintaining links to related conversation threads and knowledge base content accessed during the resolution process.

In an embodiment, the incident management manager 115 implements an intelligent escalation framework that automatically triggers elevation of tickets based on multiple factors including time in current state, SLA metrics, issue severity, and pattern matching with known critical issues. The framework coordinates with the alert manager 117 to notify appropriate management levels when escalation thresholds are reached.

In an embodiment, the incident management manager 115 maintains a correlation engine that identifies similar tickets across the system 100, enabling automatic updates of related ticket sessions with relevant resolution information. The system 100 implements a bidirectional linking mechanism that highlights related tickets within each session's context while providing direct navigation links between associated ticket details.

In an embodiment, the incident management manager 115 integrates with the store analytics manager 116 to incorporate location-specific environmental factors into ticket prioritization and routing decisions. The system 100 automatically adjusts ticket handling based on store-specific conditions, enabling optimized resolution paths for equipment issues known to be impacted by local environmental factors.

In an embodiment, the store analytics manager 116 employs a hierarchical pattern recognition system that processes equipment issue data through multiple analysis layers. The first layer uses clustering algorithms to group similar equipment issues based on failure characteristics and environmental parameters, while the second layer applies regression analysis to identify correlations between environmental conditions and failure rates.

In an embodiment, the store analytics manager 116 maintains location-specific equipment performance machine learning models that are continuously updated based on incoming issue reports and resolution outcomes. These models incorporate time-series analysis to track how environmental factors like humidity and temperature impact maintenance needs over different seasonal periods, enabling predictive maintenance recommendations tailored to each store's specific operating environment.

In an embodiment, the store analytics manager 116 implements a feedback loop system that evaluates the effectiveness of maintenance procedures against environmental conditions. The system 100 tracks resolution success rates and equipment longevity metrics to automatically refine its correlation models, adjusting maintenance schedules and procedures based on validated patterns between environmental factors and equipment performance.

In an embodiment, the store analytics manager 116 utilizes a multi-modal data fusion architecture to combine structured equipment data with unstructured maintenance notes and environmental sensor data. The system 100 applies natural language processing to extract relevant environmental impact indicators from maintenance records while correlating these with quantitative environmental measurements to build comprehensive location-specific equipment behavior profiles.

In an embodiment, the store analytics manager 116 implements a data collection pipeline that aggregates environmental data from multiple sources including store location information, equipment maintenance records, and operational metrics. The system 100 processes both structured environmental sensor data and unstructured maintenance notes through specialized data adapters that normalize inputs for consistent analysis while preserving the relationships between environmental conditions and equipment performance.

In an embodiment, the store analytics manager 116 employs pattern recognition algorithms to analyze equipment issues in relation to environmental factors such as humidity levels and geographical location. The system 100 maintains location-specific performance profiles that track how different environmental conditions impact equipment maintenance needs, enabling customized maintenance procedures for stores operating in distinct environmental conditions like humid environments.

In an embodiment, the store analytics manager 116 coordinates with the incident management manager 115 to correlate environmental patterns with equipment issues across multiple stores. The system 100 implements a feedback loop that continuously updates its environmental impact models based on ticket resolution outcomes and maintenance effectiveness, allowing for dynamic adjustment of maintenance recommendations based on validated environmental correlations.

In an embodiment, the store analytics manager 116 processes environmental data through a multi-stage analysis pipeline that first identifies baseline environmental conditions for each store location, then tracks deviations that correlate with equipment issues. The system 100 maintains separate analysis threads for different equipment types, enabling precise tracking of how specific environmental factors impact different categories of store equipment.

In an embodiment, the store analytics manager 116 implements a predictive analysis framework that uses historical environmental data and equipment performance patterns to forecast potential maintenance needs. The system 100 generates store-specific risk assessments based on current environmental conditions and historical equipment behavior patterns, enabling proactive maintenance scheduling tailored to each store's unique operating environment.

In an embodiment, the store analytics manager 116 and alert manager 117 share a synchronized event processing pipeline that ensures consistent handling of environmental data and trending issues across multiple stores. The system 100 implements event ordering mechanisms that maintain causal relationships between environmental patterns and equipment issues while supporting parallel processing of analytics data from different store locations.

In an embodiment, the store analytics manager 116 and alert manager 117 implement a priority-based event processing system that ensures critical equipment issues and environmental correlations are processed with minimal latency. The system 100 maintains separate processing queues for different priority levels while preserving event ordering within each queue, enabling rapid response to urgent issues while ensuring comprehensive analysis of all environmental data.

In an embodiment, the alert manager 117 implements a multi-stage analysis pipeline to process analytics data from the store analytics manager 116. The first stage applies classification algorithms to categorize equipment issues based on severity, frequency, and environmental correlation strength, while the second stage uses these classifications to determine notification urgency and recipient targeting.

In an embodiment, the alert manager 117 maintains a dynamic notification priority system that weighs multiple factors including issue severity, number of affected stores, rate of occurrence, and historical resolution metrics. The system 100 automatically adjusts notification priority levels based on pattern recognition across conversation threads and equipment failure data, enabling rapid escalation of emerging widespread issues.

In an embodiment, the alert manager 117 coordinates with the incident management manager 115 to track resolution status across related tickets, automatically generating trend alerts when similar issues appear across multiple stores or when environmental factors indicate increased risk of specific equipment failures. The notification delivery system implements role-based routing to ensure alerts reach appropriate management levels based on issue scope and severity.

In an embodiment, the alert manager 117 employs a notification delivery framework that supports multiple communication channels including in-app alerts, email, and integration with external notification systems. The framework implements guaranteed delivery mechanisms with acknowledgment tracking and automatic re-routing of unacknowledged critical alerts to alternate contacts.

In an embodiment, the integration manager 118 implements a message queue architecture to ensure reliable asynchronous communication between system components, with guaranteed message delivery and automatic failover capabilities. The system 100 maintains conversation state through a distributed cache that enables seamless handoff between automated and live support while preserving full interaction context.

In an embodiment, the integration manager 118 implements a message queue architecture that maintains separate queues for different types of system communications including ticket updates, knowledge base queries, and live agent handoffs. The system 100 employs a publisher-subscriber model where components can subscribe to relevant message types, enabling decoupled and scalable communication between the knowledge manager 113, conversation manager 114, and incident management manager 115.

In an embodiment, the distributed cache system maintains conversation state through a multi-tiered storage architecture. The first tier provides fast access to active conversation contexts and session data, while additional tiers handle historical conversation data and related ticket information. This tiered approach enables rapid access to current conversations while maintaining comprehensive interaction history.

In an embodiment, the failover mechanisms include automatic message replication across multiple queue instances and cache nodes. If a primary queue or cache node becomes unavailable, the system 100 automatically fails over to redundant instances while maintaining message ordering and conversation state integrity. The system 100 implements health monitoring and automatic recovery procedures to restore failed components without losing conversation context.

In an embodiment, the integration manager 118 coordinates state synchronization between the distributed cache and external systems. The system 100 maintains consistency through transactional updates that ensure conversation state remains synchronized across all system components even during component failures or failover events.

In an embodiment, the integration manager 118 implements a distributed transaction management system that coordinates operations across active support sessions. The system 100 maintains data consistency through a two-phase commit protocol when updating conversation state, ticket information, and knowledge base content across the various managers, ensuring atomic updates even during concurrent operations.

In an embodiment, the integration manager 118 maintains a global session registry that tracks all active support sessions and their associated resources. The registry implements lease-based access control mechanisms that prevent resource conflicts during concurrent operations while enabling efficient resource cleanup when sessions terminate or transition between shifts.

In an embodiment, the conversation manager 114 and incident management manager 115 coordinate through a shared session management framework that maintains isolated conversation contexts for each active support session. The framework implements optimistic locking mechanisms when multiple users or system components attempt to update the same conversation thread or ticket, preventing data conflicts while preserving update order integrity.

In an embodiment, the system implements a distributed state management protocol that maintains consistency between the conversation manager 114, incident management manager 115, and external systems. The protocol ensures that ticket states, conversation contexts, and support session information remain synchronized across all system components through a combination of message queuing and state replication mechanisms.

In an embodiment, the system 100 implements a hierarchical synchronization protocol that coordinates state updates across all active components while minimizing communication overhead. The protocol uses a combination of local caches and distributed locks to maintain consistency, with different synchronization strategies applied based on the criticality and scope of the state changes being coordinated.

In an embodiment, the system 100 implements real-time monitoring of synchronization health across all components. The monitoring system tracks synchronization latency, detects potential conflicts or deadlocks, and automatically initiates recovery procedures when synchronization issues are detected. This ensures reliable operation of the distributed system while maintaining data consistency across all active sessions and components.

Having described the components and interactions of system 100, various methods for adaptive support and management will now be detailed. These methods may be implemented using the components of system 100 to provide location-aware support capabilities while maintaining conversation continuity across shift changes. The methods enable customized responses based on store-specific conditions and seamless ticket management across multiple users.

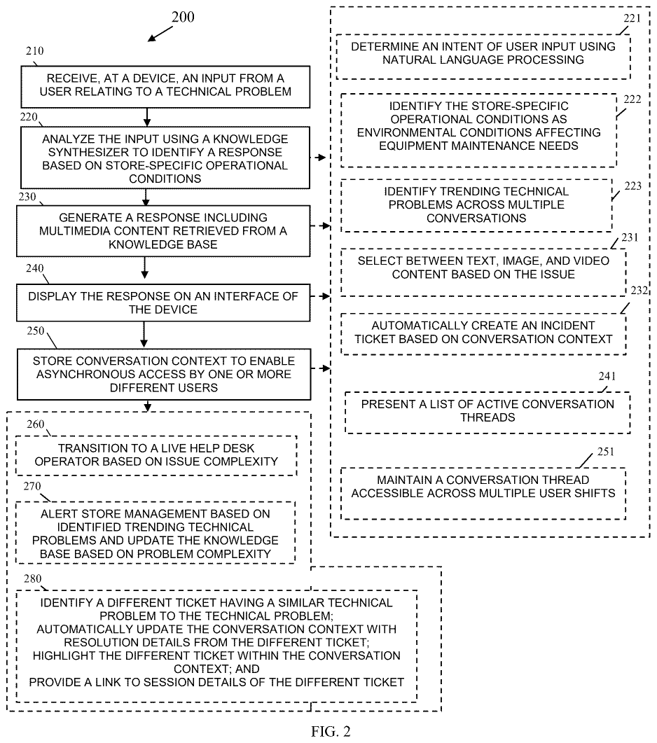

FIG. 2 illustrates a flow diagram of a method 200 for adaptive support and management, according to an example embodiment. The software module(s) that implements the method 200 is referred to as a “support integration manager.” The support integration manager is implemented as executable instructions programmed and residing within memory and/or a non-transitory computer-readable (processor-readable) storage medium and executed by one or more processors of one or more devices. The processor(s) of the device(s) that executes the support integration manager are specifically configured and programmed to process the support integration manager. The support integration manager has access to one or more network connections during its processing. The connections can be wired, wireless, or a combination of wired and wireless.

In an embodiment, the device that executes the support integration manager is cloud 110. In an embodiment, the device that executes the support integration manager is server 120. In an embodiment, the devices that execute the support integration manager are cloud 110 and user-operated device 130. In an embodiment, the support integration manager is all of, or some combination of 113-119-1 and/or 133.

At 210, the support integration manager receives, at a user-operated device, an input from a user relating to a technical problem. The input is received in a natural language written or spoken format.

At 220, the support integration manager analyzes the input using a knowledge synthesizer (e.g., knowledge manager 113) to identify a response based on store-specific operational conditions. In an embodiment, at 221, the support integration manager determines an intent of user input using natural language processing. In an embodiment, at 222, the support integration manager identifies the store-specific operational conditions affecting equipment maintenance needs. In an embodiment, at 223, the support integration manager identifies trending technical problems across multiple conversations.

At 230, the support integration manager generates a response including multimedia content retrieved from a knowledge base. In an embodiment, at 231, the support integration manager selects between text, image, and video content based on the issue. In an embodiment, at 232, the support integration manager automatically creates an incident ticket based on conversation context.

At 240, the support integration manager displays the response on an interface of the user-operated device 130. In an embodiment, at 241, the support integration manager presents a list of active conversation threads.

At 250, the support integration manager stores conversation context to enable asynchronous access by one or more different users. In an embodiment, at 251, the support integration manager maintains a conversation thread accessible across multiple user shifts.

In an embodiment, at 260, the support integration manager transitions to a live helpdesk operator based on issue complexity. In an embodiment, at 270, the support integration manager alerts store management based in identified trending technical problems and updates the knowledge base based on problem complexity.

In an embodiment, at 280, the support integration manager identifies a different ticket having a similar technical problem to the technical problem. The support integration manager automatically updates the conversation context with resolution details from the different ticket. The support integration manager highlights the different ticket within the conversation context and provides a link to session details of the different ticket.

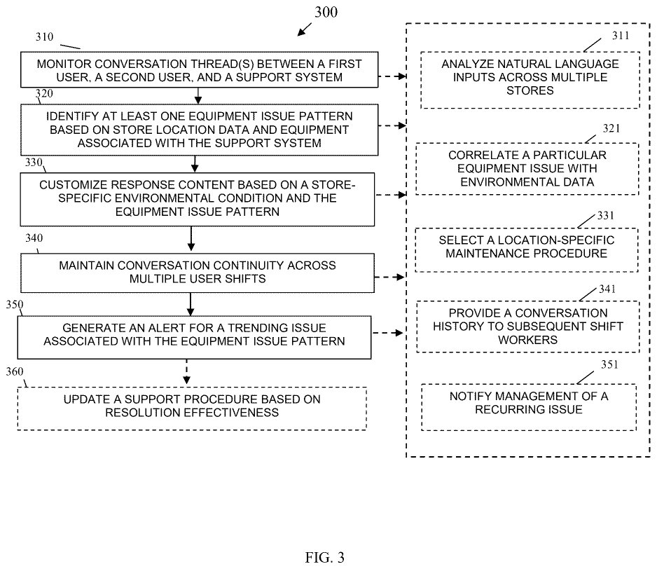

FIG. 3 illustrates a flow diagram of another method 300 for adaptive support and management, according to an example embodiment. The software module(s) that implements the method 300 is referred to as a “support system integrator.” The support system integrator is implemented as executable instructions programmed and residing within memory and/or a non-transitory computer-readable (processor-readable) storage medium and executed by one or more processors of one or more devices. The processor(s) of the device(s) that executes the support system integrator are specifically configured and programmed to process the support system integrator. The support system integrator has access to one or more network connections during its processing. The network connections can be wired, wireless, or a combination of wired and wireless.

In an embodiment, the device that executes the support system integrator is cloud 110. In an embodiment, the device that executes the support system integrator is server 120. In an embodiment, the devices that execute the support system integrator are cloud 110 and user-operated device 130.

In an embodiment, the support system integrator is all of, or some combination of 113-119-1, 133, and/or method 200. The support system integrator presents another and, in some ways, enhanced processing perspective from that which was discussed above with the method 200 of the FIG. 2.

At 310, the support system integrator monitors one or more conversation threads between a first user, at least one second user, and a support system (119-1 or 123). In an embodiment, the support system integrator analyzes natural language inputs across multiple stores.

At 320, the support system integrator identifies at least one equipment issue pattern based on store location data and equipment associated with the support system. In an embodiment, at 321, the support system integrator correlates a particular equipment issue with environmental data.

At 330, the support system integrator customizes a response based on a store-specific environmental condition and the equipment issue pattern. In an embodiment, at 331, the support system integrator selects a location-specific maintenance procedure.

At 340, the support system integrator maintains conversation continuity across multiple user shifts. In an embodiment, at 341, the support system integrator provides a conversation history to subsequent shift workers.

At 350, the support system integrator generates an alert for a trending issue associated with the equipment issue pattern. In an embodiment, at 351, the support system integrator notifies management of recurring issues. In an embodiment, at 360, the support system integrator updates a support procedure based on resolution effectiveness.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving, at a device, an input from a user relating to a technical problem;
analyzing the input using a knowledge synthesizer to identify a response based on store-specific operational conditions;
generating a response comprising multimedia content retrieved from a knowledge base;
displaying the response on an interface of the device; and
storing conversation context to enable asynchronous access by one or more different users.

2. The method of claim 1, wherein analyzing the input comprises determining an intent of a user input using natural language processing.

3. The method of claim 1, wherein analyzing the input comprises identifying the store-specific operational conditions as environmental conditions affecting equipment maintenance needs.

4. The method of claim 1, wherein analyzing the input comprises identifying trending technical problems across multiple conversations.

5. The method of claim 1, wherein generating the response comprises selecting between text, image, and video content based on the technical problem.

6. The method of claim 1, wherein generating the response comprises automatically creating an incident ticket based on conversation context.

7. The method of claim 1, wherein displaying the response comprises presenting a list of active conversation threads.

8. The method of claim 1, wherein storing the conversation context comprises maintaining a conversation thread accessible across multiple user shifts.

9. The method of claim 1, further comprising transitioning to a live help desk operator based on problem complexity.

10. The method of claim 1, further comprising alerting store management based on identified trending technical problems and updating the knowledge base based on resolution outcomes.

11. The method of claim 1, further comprising:
identifying a different ticket having a similar technical problem to the technical problem;
automatically updating the conversation context with resolution details from the different ticket;
highlighting the different ticket within the conversation context; and
providing a link to session details of the different ticket.

12. A method, comprising:
monitoring one or more conversation threads between a first user, a second user, and a support system;
identifying at least one equipment issue pattern based on store location data and equipment associated with the support system;
customizing response content based on a store-specific environmental condition and the at least one equipment issue pattern;
maintaining conversation continuity for the one or more conversation threads across multiple user shifts; and
generating an alert for a trending issue associated with the at least one equipment issue pattern.

13. The method of claim 12, wherein monitoring the one or more conversation threads comprises analyzing natural language inputs across multiple stores and multiple users.

14. The method of claim 12, wherein identifying the at least one equipment issue pattern comprises correlating a particular equipment issue with environmental data.

15. The method of claim 12, wherein customizing the response content comprises selecting a location-specific maintenance procedure.

16. The method of claim 12, wherein maintaining the conversation continuity comprises providing a conversation history to subsequent shift workers.

17. The method of claim 12, wherein generating the alert comprises notifying management of a recurring issue.

18. The method of claim 12, further comprising updating a support procedure based on resolution effectiveness.

19. A system, comprising:
a processor;
a memory storing instructions that, when executed by the processor, cause the processor to:
implement a knowledge synthesizer configured to analyze user inputs describing technical problems and retrieve relevant support content from a knowledge base;
implement a conversation manager configured to maintain conversation context across multiple users during shift changes;
implement an incident manager configured to create and track support tickets based on conversation context;
customize responses based on store-specific operational conditions; and
control a display to present multimedia response content including text, image and video solutions;
wherein the knowledge synthesizer, conversation manager, and incident manager operate asynchronously to enable continuous technical problem resolution across different user shifts.

20. The system of claim 19, wherein the instructions further cause the processor to:
implement an alert generator configured to:
identify trending technical problems across multiple conversations;
analyze patterns in equipment issues based on store location data; and
notify management of recurring technical problems based on analyzed patterns.
